(19) United States
(12) Patent Application Publication
(10) Pub. No.: US 2022/0316208 A1
(43) Pub. Date: Oct. 6, 2022

(54) SOUND-ABSORBING NON-COMBUSTIBLE CEILING MATERIAL AND METHOD FOR MANUFACTURING THE SAME

(71) Applicant: ZENFIX CO., LTD., Busan (KR)

(72) Inventors: Young Chul KWON, Busan (KR); Seong-Hee CHOI, Busan (KR); Chang-Seong YUN, Busan (KR)

(73) Assignee: ZENFIX CO., LTD., Busan (KR)

(21) Appl. No.: 17/440,482

(22) PCT Filed: May 28, 2021
(86) PCT No.: PCT/KR2021/006640

§ 371 Date: Sep. 17, 2021

(30) Foreign Application Priority Data
May 29, 2020 (KR) 10-2020-0065226

(51) Int. Cl. E04B 9/04; B21D 28/26; E04B 9/00; B32B 37/12; B32B 38/04; B32B 3/26; B32B 17/02; B32B 17/06; B32B 7/12; B32B 15/18

(52) U.S. Cl. CPC E04B 9/045; B21D 28/26; E04B 9/001; B32B 37/1207; B32B 38/04; B32B 3/266; B32B 17/02; B32B 17/061; B32B 7/12; B32B 15/18; B32B 2307/102; B32B 2307/3065; B32B 2311/30; B32B 2315/08; B32B 2037/1215; B32B 2255/06; B32B 2255/205; B32B 2307/732; B32B 2419/00; B32B 2038/047

(57) ABSTRACT

A sound-absorbing non-combustible ceiling material and a method for manufacturing the same are disclosed. The method (S100) for manufacturing the sound-absorbing non-combustible ceiling material installed in a ceiling of a building includes a panel processing step (S1000) of processing each of a first panel including a metal and a second panel absorbing a sound wave; and a panel attaching step (S2000) of attaching the first panel and the second panel. The first panel includes a plurality of openings, and the first panel and the second panel are coupled by an adhesive layer to form the sound-absorbing non-combustible ceiling material.

### TECHNICAL FIELD

The present disclosure relates to a sound-absorbing non-combustible ceiling material and a method for manufacturing the same. In particular, the present disclosure relates to a sound-absorbing non-combustible ceiling material with incombustibility while absorbing a noise and a method for manufacturing the same.

### BACKGROUND ART

Ceiling materials (or ceiling plates), which are mainly used in the interior of buildings, can provide various functions including aesthetics. For example, the ceiling material contains a non-combustible material and can suppress or prevent the spread of fire in case of fire. For example, the ceiling material may include a sound absorbing material.

There may be required a method for effectively manufacturing a ceiling material that contains a non-combustible material while being a sound absorbing panel. That is, a sound-absorbing non-combustible ceiling material may be required in the construction of a safe and comfortable building.

Prior Art Document: Korean Patent No. 10-1898871

### DISCLOSURE

### Technical Problem

An object of the present disclosure is to address the above-described and other problems.

Another object of the present disclosure is to provide a sound-absorbing non-combustible ceiling material and a method for manufacturing the same capable of emitting relatively little toxic gases in case of fire.

Another object of the present disclosure is to provide a sound-absorbing non-combustible ceiling material and a method for manufacturing the same capable of absorbing sound waves.

### Technical Solution

In order to achieve the above-described and other objects, in one aspect of the present disclosure, there is provided a method (S100) for manufacturing a sound-absorbing non-combustible ceiling material installed in a ceiling of a building, the method comprising a panel processing step (S1000) of processing each of a first panel including a metal and a second panel absorbing a sound wave; and a panel attaching step (S2000) of attaching the first panel and the second panel, wherein the first panel includes a plurality of openings, and wherein the first panel and the second panel are coupled by an adhesive layer to form the sound-absorbing non-combustible ceiling material.

In another aspect of the present disclosure, there is provided a sound-absorbing non-combustible ceiling material installed in a ceiling of a building, comprising a first panel including a plurality of openings; a second panel accommodated in and coupled to the first panel, the second panel absorbing at least a portion of an incident sound wave; and an adhesive layer positioned between the first panel and the second panel and coupling the first panel and the second panel, wherein the first panel includes a perforated plate in which the plurality of openings are formed; and a connection portion formed to be bent and extended from the perforated plate.

### Advantageous Effects

Effects of a sound-absorbing non-combustible ceiling material and a method for manufacturing the same according to the present disclosure are described as follows.

According to at least one embodiment of the present disclosure, the present disclosure can emit relatively little toxic gases in case of fire.

According to at least one embodiment of the present disclosure, the present disclosure can absorb sound waves.

Additional scope of applicability of the present disclosure will become apparent from the detailed description given blow. However, it should be understood that the detailed description and specific examples such as embodiments of the present disclosure are given merely by way of example, since various changes and modifications within the spirit and scope of the present disclosure will become apparent to those skilled in the art from the detailed description.

### DESCRIPTION OF DRAWINGS

FIG. 1 illustrates a first panel 100 according to an embodiment of the present disclosure.

FIG. 2 illustrates that a second panel and a third panel according to an embodiment of the present disclosure are laminated.

FIG. 3 illustrates a sound-absorbing non-combustible ceiling material 10 according to an embodiment of the present disclosure.

FIG. 4 illustrates a cross section of a sound-absorbing non-combustible ceiling material 10 taken along line A-A of FIG. 3.

FIG. 5 is a flow chart illustrating a method for manufacturing a sound-absorbing non-combustible ceiling material according to an embodiment of the present disclosure.

FIG. 6 is a flow chart illustrating a panel processing step S1000 according to an embodiment of the present disclosure.

FIG. 7 is a flow chart illustrating a first panel processing step S1100 according to an embodiment of the present disclosure.

FIG. 8 is a flow chart illustrating an absorption layer processing step S1200 according to an embodiment of the present disclosure.

FIG. 9 is a flow chart illustrating a combination step S1210 according to an embodiment of the present disclosure.

FIG. 10 illustrates a panel attaching step S2000 according to an embodiment of the present disclosure.

FIG. 11 illustrates that a rectangular shaped sound-absorbing non-combustible ceiling material 10 is installed on the ceiling of the building.

### MODE FOR INVENTION

Reference will now be made in detail to embodiments of the disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the present disclosure, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that embodiments presented herein are not limited by the accompanying drawings. As such, the present disclosure should be construed to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being connected” or “being coupled” to other component, this should be understood to mean that another component may exist between them, although any component may be directly connected or coupled to the other component. In contrast, when any component is described as “being directly connected” or “being directly coupled” to other component, this should be understood to mean that no component exists between them.

A singular expression can include a plural expression as long as it does not have an apparently different meaning in context.

In the present disclosure, terms “include” and “have” should be understood to be intended to designate that illustrated features, numbers, steps, operations, components, parts or combinations thereof are present and not to preclude the existence of one or more different features, numbers, steps, operations, components, parts or combinations thereof, or the possibility of the addition thereof.

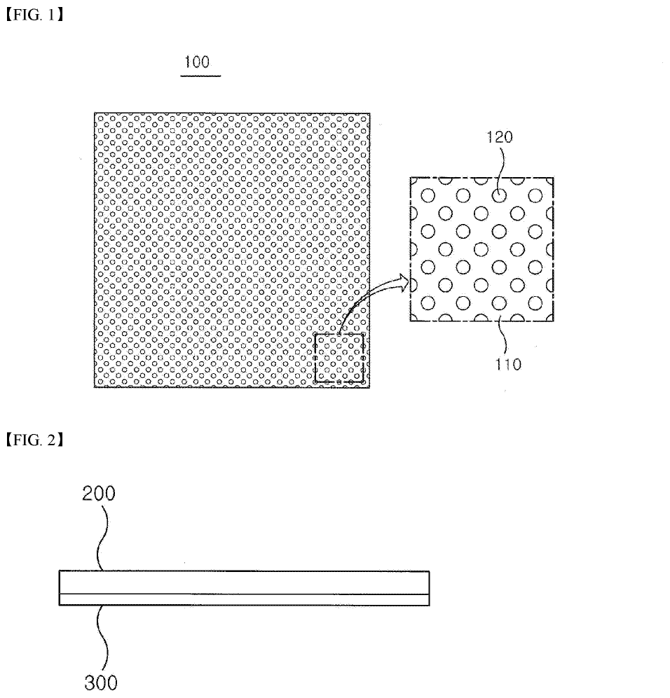

FIG. 1 illustrates a first panel 100 according to an embodiment of the present disclosure.

Referring to FIG. 1, a first panel 100 may form a plate shape. The first panel 100 may be included in a sound-absorbing non-combustible ceiling material according to an embodiment of the present disclosure. At least a portion of the first panel 100 may be made of a metal material.

For example, at least a portion of the first panel 100 may be made of cold rolled steel sheet. The steel sheet may mean a steel sheet of the first panel 100. For example, the steel sheet may be formed through pre-processing, annealing (heat treatment), plating, alloying, temper rolling, and chemical treatment processes. For example, the pre-processing of the steel sheet may be performed using an alkali solution.

For example, the plating of the steel sheet may be performed by plating the steel sheet with aluminum or by plating the steel sheet with a mixture of aluminum and zinc phosphate. For example, the plating of the steel sheet may be performed using at least one of aluminum (Al) and zinc (Zn). For example, in the plating of the steel sheet, a weight ratio of Al may be 55%, and a weight ratio of Zn may be less than or equal to 45%.

The plating of the steel sheet may be performed for a certain range of time. For example, a plating time of the steel sheet may be 3 minutes to 15 minutes. When the plating time is less than 3 minutes, a thickness of a plating layer may be excessively reduced. When the plating time exceeds 15 minutes, the thickness of the plating layer may be excessively increased. The plated steel sheet can generate relatively little toxic gases in case of fire.

At least a portion of the steel sheet may be coated with chrome as post-processing. When chrome is coated, an improvement in corrosion resistance and an aesthetic effect of the first panel 100 can be expected.

For example, a coating layer may be coated on the steel sheet. For example, at least a portion of the steel sheet may be preheated to 60 to 70 degrees Celsius (° C.) as the pre-processing process. For example, at least a portion of the steel sheet may be coated with chrome. For example, at least a portion of the steel sheet may be coated with a polyester resin. A thickness of the coated polyester resin may be 3 to 5 micrometers (μm). For example, at least a portion of the first panel 100 may be coated with ceramic. When ceramic is coated, an improvement in corrosion resistance and an aesthetic effect of the first panel 100 can be expected.

The steel sheet constituting at least a portion of the first panel 100 may form a thickness of 0.2 to 0.8 millimeters (mm). When the thickness of the steel sheet is less than 0.2 mm, it may be difficult to secure rigidity of the first panel 100. When the thickness of the steel sheet is greater than 0.8 mm, the weight of the first panel 100 may be excessively increased.

The plating layer of the steel sheet constituting at least a portion of the first panel 100 may form a thickness of 5 to 50 μm.

The first panel 100 may include a perforated plate 110. The perforated plate 110 may form an overall shape or skeleton of the first panel 100. The perforated plate 110 may have a plate shape. When the sound-absorbing non-combustible ceiling material is installed, one surface of the perforated plate 110 may be observed indoors. Other surface of the perforated plate 110 may mean a surface opposite to the one surface of the perforated plate 110.

Although not illustrated, the first panel 100 may include a protective film. The protective film may be attached to the perforated plate 110. The protective film attached to the perforated plate 110 may form a thickness of about 40 μm.

The first panel 100 may include an opening 120. The opening 20 may be formed in the perforated plate 110. The opening 20 may lead from the one surface to the other surface of the perforated plate 110. The plurality of openings 120 may be provided. The plurality of openings 120 may form a specific pattern.

The opening 120 may form a path through which sound waves generated indoors pass. On the contrary, a portion of the perforated plate 110, in which the openings 120 are not formed, may be an area from which the sound waves are reflected or/and an area that reflects heat in case of fire.

The opening 120 may be formed in a specific shape. For example, the opening 120 may be formed in the shape of a circle. A diameter of the opening 120 may be, for example, 1.8 mm.

An “aperture ratio” of the first panel 100 may be defined. The aperture ratio of the first panel 100 may refer to a ratio of an area, in which the openings 120 are formed, to the total area of the perforated plate 110. For example, the aperture ratio of the first panel 100 may be 10 to 40%.

When the aperture ratio of the first panel 100 is less than 10%, a ratio of sound waves passing through the first panel 100 may be excessively reduced. In this case, a sound absorption function of the sound-absorbing non-combustible ceiling material may be excessively reduced.

When the aperture ratio of the first panel 100 is greater than 40%, it may be difficult to secure rigidity of the first panel 100. When the aperture ratio of the first panel 100 is greater than 40%, a heat reflection function of the first panel 100 may be excessively reduced.

FIG. 2 illustrates that a second panel and a third panel according to an embodiment of the present disclosure are laminated.

Referring to FIG. 2, the sound-absorbing non-combustible ceiling material according to an embodiment of the present disclosure may include a second panel 200. The second panel 200 may be referred to as an “absorption layer” or/and an “absorption panel”. The second panel 200 may absorb at least a portion of the sound wave incident on the second panel 200. The second panel 200 may include a heat resistant material.

A thickness of the second panel 200 may be 0.2 to 1.3 mm. When the thickness of the second panel 200 is greater than 1.3 mm, the total thickness of the sound-absorbing non-combustible ceiling material may be excessively increased, and thus a difficulty in installing the ceiling material may occur. When the thickness of the second panel 200 is less than 0.2 mm, a sound wave absorptivity of the second panel 200 may be excessively reduced. The sound wave absorptivity of the second panel 200 may refer to a ratio of intensity of the absorbed sound wave to intensity of the sound wave incident on the second panel 200.

The second panel 200 may include silicon dioxide (SiO₂). For example, silicon dioxide (SiO₂) of the second panel 200 may form a weight ratio of 75% to 96%. For example, silicon dioxide (SiO₂) of the second panel 200 may form the second panel 200 in the form of glass fibers. The second panel 200 may be non-combustible. The second panel 200 may emit relatively little toxic gases in case of fire.

A shape of the second panel 200 may be entirely similar to the shape of the perforated plate 110 (see FIG. 1). One surface of the second panel 200 may face a third panel 300. For example, one surface of the second panel 200 may be attached to the third panel 300. Other surface of the second panel 200 may be exposed to the outside.

The sound-absorbing non-combustible ceiling material according to an embodiment of the present disclosure may include the third panel 300. The third panel 300 may be referred to as an “adhesive layer” or/and an “adhesive panel”. The adhesive layer 300 may include a hot-melt. The adhesive layer 300 may be attached to one surface of the second panel 200 to form a layer.

FIG. 3 illustrates a sound-absorbing non-combustible ceiling material 10 according to an embodiment of the present disclosure. FIG. 3 may be an exploded perspective view of the sound-absorbing non-combustible ceiling material 10.

Referring to FIG. 3, the first panel 100 and the second panel 200 may face each other. Other surface of the first panel 100 may face one surface of the second panel 200. The adhesive layer 300 may be positioned between the first panel 100 and the second panel 200. The adhesive layer 300 may couple the first panel 100 and the second panel 200.

The first panel 100 may include a connection portion 130. The connection portion 130 may be formed to be bent and extended from the perforated plate 110. The connection portion 130 may be integrally formed with the perforated plate 110. For example, the connection portion 130 may be formed integrally with the perforated plate 110 while being bent with respect to the perforated plate 110.

The connection portion 130 may be a portion connected or fastened to the ceiling. The connection portion 130 may be coupled or connected to the perimeter of the perforated plate 110. The connection portion 130 may be referred to as a “frame unit”.

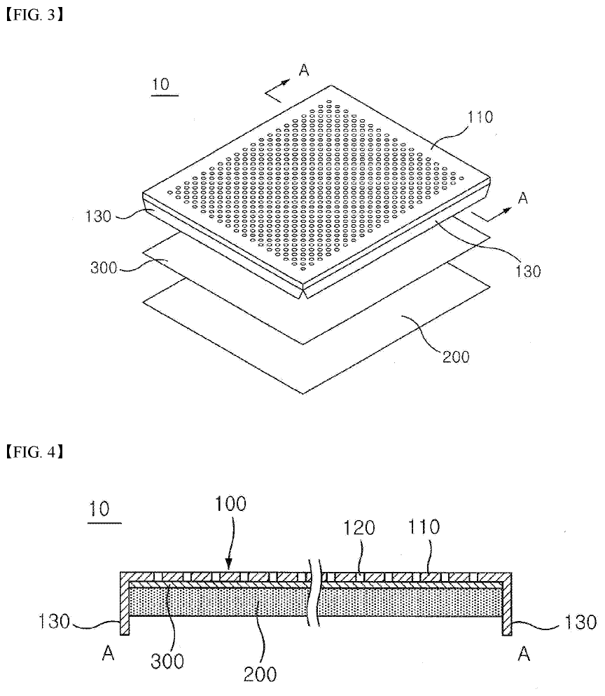

FIG. 4 illustrates a cross section of a sound-absorbing non-combustible ceiling material 10 taken along line A-A of FIG. 3.

Referring to FIG. 4, one surface of the perforated plate 110 may be exposed to the outside. Other surface of the perforated plate 110 may be in contact with the adhesive layer 300. The opening 120 may be formed in the perforated plate 110.

At least a portion of the sound wave propagating toward one surface of the perforated plate 110 may pass through the opening 120 and reach the absorption layer 200 or/and the adhesive layer 300. At least a portion of the sound wave reaching the absorption layer 200 or/and the adhesive layer 300 may be absorbed by the absorption layer 200 or/and the adhesive layer 300.

The absorption layer 200 may be accommodated in the first panel 100. For example, the absorption layer 200 may be accommodated in a space formed by the perforated plate 110 and the connection portion 130. For example, the absorption layer 200 may be supported by the first panel 100.

FIG. 5 is a flow chart illustrating a method for manufacturing a sound-absorbing non-combustible ceiling material according to an embodiment of the present disclosure. FIG. 5 may be described with reference to FIGS. 1 to 4.

Referring to FIGS. 1 to 5, a method S100 for manufacturing the sound-absorbing non-combustible ceiling material according to an embodiment of the present disclosure may comprise a panel processing step S1000. In the panel processing step S1000, the first panel 100 and the second panel 200 may be processed. For example, in this step S1000, the opening 120 and the connection portion 130 may be formed in the first panel 100. For example, in this step S1000, the adhesive layer 300 may be applied to the absorption layer 200.

The method S100 for manufacturing the sound-absorbing non-combustible ceiling material according to an embodiment of the present disclosure may comprise a panel attaching step S2000. In this step S2000, the absorption layer 200 may be attached to the first panel 100. In this step S2000, the second panel 200 and the first panel 100 may be coupled to form the sound-absorbing non-combustible ceiling material 10.

The method S100 for manufacturing the sound-absorbing non-combustible ceiling material according to an embodiment of the present disclosure may comprise a step S3000 of installing the sound-absorbing non-combustible ceiling material. In this step S3000, the sound-absorbing non-combustible ceiling material 10 may be installed on the ceiling of the building.

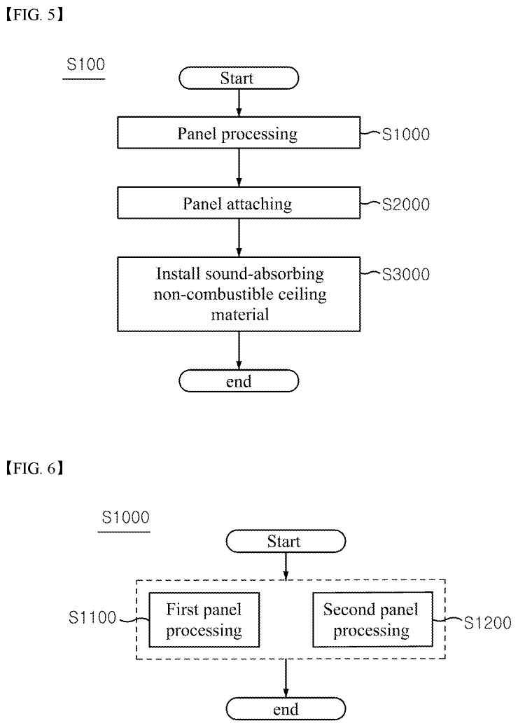

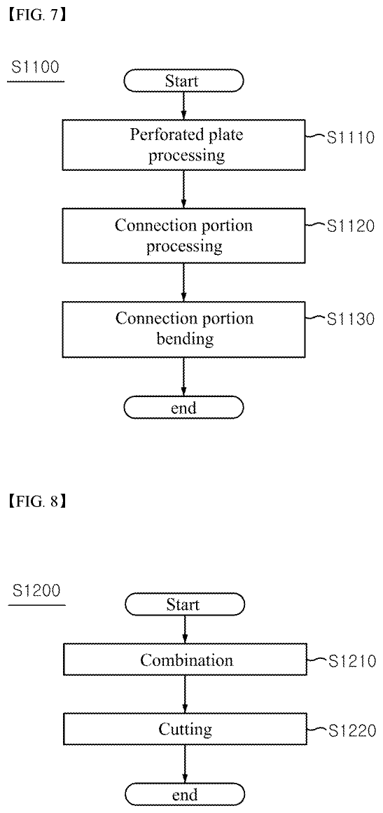

FIG. 6 is a flow chart illustrating a panel processing step S1000 according to an embodiment of the present disclosure. FIG. 6 may be described with reference to FIGS. 1 to 5.

Referring to FIGS. 1 to 6, the panel processing step S1000 according to an embodiment of the present disclosure may comprise a first panel processing step S1100. In this step S1100, a steel sheet may be processed to form the first panel 100.

The panel processing step S1000 according to an embodiment of the present disclosure may comprise a second panel processing step S1200. The second panel processing step S1200 may be referred to as an “absorption layer processing step”. In this step S1200, glass fibers may be processed to form the absorption layer 200. In this step S1200, the adhesive layer 300 may be applied (or coupled or formed) to the absorption layer 200.

The first panel processing step S1100 and the absorption layer processing step S1200 may be in a parallel relationship. For example, one of the first panel processing step S1100 and the absorption layer processing step S1200 may be first performed. For example, the first panel processing step S1100 and the absorption layer processing step S1200 may be performed at the same time.

FIG. 7 is a flow chart illustrating the first panel processing step S1100 according to an embodiment of the present disclosure. FIG. 7 may be described with reference to FIGS. 1 to 6.

Referring to FIGS. 1 to 7, the first panel processing step S1100 according to an embodiment of the present disclosure may comprise a perforated plate processing step S1110. In this step S1110, the opening 120 may be formed in the metal plate 110. That is, in this step S1110, the opening 120 may be formed in the perforated plate 110.

The first panel processing step S1100 according to an embodiment of the present disclosure may comprise a connection portion processing step S1120. In this step S1120, an edge portion of the perforated plate 110 may be processed. The edge portion of the perforated plate 110 may be the connection portion 130. The edge portion of the perforated plate 110 may have a shape elongated in one direction. For example, in this step S1120, an end of the edge portion of the perforated plate 110 may be chamfered. For example, in this step S1120, a hole may be formed in the edge portion of the perforated plate 110.

The first panel processing step S1100 according to an embodiment of the present disclosure may comprise a connection portion bending step S1130. In this step S1130, the connection portion 130 may be bent with respect to the perforated plate 110. That is, in this step S1130, the connection portion 130 may form an angle with the perforated plate 110. For example, in this step S1130, the connection portion 130 may form a right angle with the perforated plate 110.

FIG. 8 is a flow chart illustrating the absorption layer processing step S1200 according to an embodiment of the present disclosure. FIG. 8 may be described with reference to FIGS. 1 to 7.

Referring to FIGS. 1 to 8, the absorption layer processing step S1200 according to an embodiment of the present disclosure may comprise a combination step S1210. In this step S1210, the adhesive layer 300 may be laminated on and coupled to the absorption layer 200. In this step S1210, for example, the adhesive layer 300 may be laminated on and coupled to the absorption layer 200 using a spray method or a dot method. For another example, in this step S1210, the adhesive layer 300 may be laminated on the absorption layer 200 through a laminating process.

The absorption layer processing step S1200 according to an embodiment of the present disclosure may comprise a cutting step S1220. In the cutting step S1220, the absorption layer 200 and the adhesive layer 300 that are combined may be cut to correspond to the size of the first panel 100.

FIG. 9 is a flow chart illustrating the combination step S1210 according to an embodiment of the present disclosure. FIG. 9 may be described with reference to FIGS. 1 to 8.

Referring to FIGS. 1 to 9, in the combination step S1210 according to an embodiment of the present disclosure, the adhesive layer 300 may be disposed on and coupled to the absorption layer 200 through a laminating process.

The combination step S1210 according to an embodiment of the present disclosure may comprise a laminating step S1211. In the laminating step S1211, a material forming the adhesive layer 300 may be disposed on one surface of the absorption layer 200. The material for forming the adhesive layer 300 may be, for example, hot melt.

The combination step S1210 according to an embodiment of the present disclosure may comprise a heat bonding step S1212. In this step S1212, heat may be provided to the absorption layer 200 and the hot melt. In this step S1212, the hot melt may form the adhesive layer 300.

The combination step S1210 according to an embodiment of the present disclosure may comprise a cooling step S1213. In this step S1213, the absorption layer 200 and the adhesive layer 300 may be cooled. That is, in this step S1213, a temperature of the absorption layer 200 and the adhesive layer 300 may be lowered.

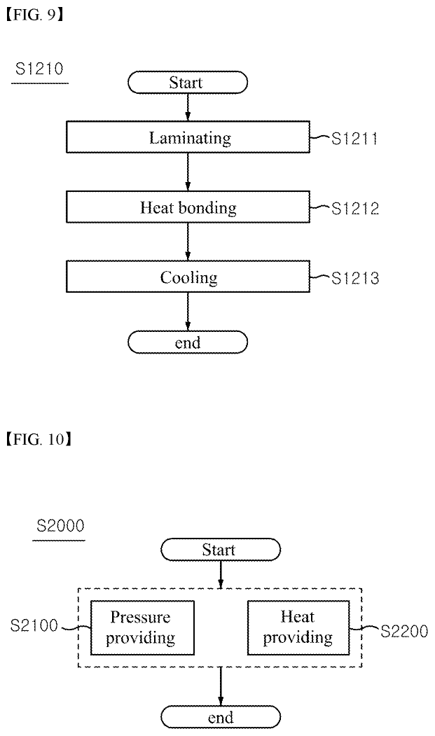

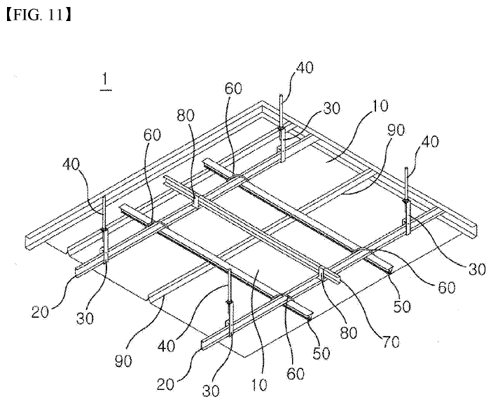

FIG. 10 illustrates the panel attaching step S2000 according to an embodiment of the present disclosure. FIG. 10 may be described with reference to FIGS. 1 to 9.

Referring to FIGS. 1 to 10, the panel attaching step S2000 according to an embodiment of the present disclosure may comprise a pressure providing step S2100. In this step S2100, a pressure may be provided to the first panel 100 and the absorption layer 200. A direction of the pressure provided to the first panel 100 and the absorption layer 200 in this step S2100 may be a direction in which the first panel 100 and the absorption layer 200 approach each other.

The panel attaching step S2000 according to an embodiment of the present disclosure may comprise a heat providing step S2200. In this step S2200, heat may be provided to at least one of the first panel 100 and the absorption layer 200. In this step S2200, the temperature of the first panel 100 and the absorption layer 200 may be, for example, 100 to 250° C.

The pressure providing step S2100 and the heat providing step S2200 may be in a parallel relationship. For example, one of the pressure providing step S2100 and the heat providing step S2200 may be first performed. For example, the pressure providing step S2100 and the heat providing step S2200 may be performed at the same time.

When heat and pressure are applied to the first panel 100 and the absorption layer 200, heat and pressure may be provided to the adhesive layer 300 through the first panel 100 and the absorption layer 200. When heat and pressure are provided to the adhesive layer 300, the adhesive layer 300 may couple the first panel 100 and the absorption layer 200.

FIG. 11 illustrates that a rectangular shaped sound-absorbing non-combustible ceiling material 10 is installed on the ceiling of the building. A plurality of components may be coupled to the sound-absorbing non-combustible ceiling material 10 so that the sound-absorbing non-combustible ceiling material 10 is installed on the ceiling of the building. The plurality of components may be coupled to the sound-absorbing non-combustible ceiling material 10 to form a ceiling assembly 1.

Referring to FIG. 11, the ceiling assembly 1 may include the sound-absorbing non-combustible ceiling material 10. The sound-absorbing non-combustible ceiling material 10 may mean the sound-absorbing non-combustible ceiling material 10 described above with reference to FIGS. 1 to 10.

The ceiling assembly 1 may include a carrying 20. The carrying 20 may be positioned under the ceiling. The carrying 20 may form a shape of a beam. The plurality of carryings 20 may be provided. The carrying 20 may have rigidity. The carrying 20 may have a shape elongated in one direction.

The ceiling assembly 1 may include a hanger 30. The hanger 30 may be coupled or fixed to the carrying 20. The hanger 30 may be fastened to the carrying 20. The hanger 30 may be supported on the ceiling. For example, the hanger 30 may be coupled to a vertical bolt 40 and supported on the ceiling. One end of the vertical bolt 40 may be fixed to the ceiling, and other end of the vertical bolt 40 may be fixed to the hanger 30. The hanger 30 may be coupled to the carrying 20 to support the carrying 20. That is, the hanger 30 may allow the carrying 20 to maintain a predetermined distance from the ceiling. The plurality of carryings 20 may be provided. The two adjacent carryings 20 among the plurality of carryings 20 may maintain a predetermined distance.

The ceiling assembly 1 may include a clip bar 50. The clip bar 50 may have a shape elongated in a longitudinal direction. The plurality of clip bars 50 may be provided. For example, the clip bar 50 may be formed to extend in a direction intersecting a longitudinal direction of the carrying 20. The clip bar 50 may be coupled or fixed to the carrying 20. For example, the clip bar 50 may be coupled or fixed to the carrying 20 by a wire clip 60. The clip bar 50 may be positioned under the carrying 20.

The ceiling assembly 1 may include a minor channel 70. The plurality of minor channels 70 may be provided. The minor channel 70 may be positioned on the carrying 20. The minor channel 70 may be coupled or fixed to the carrying 20. The minor channel 70 may be coupled or fixed to the carrying 20 by, for example, a minor clip 80. The minor channel 70 may uniformly maintain a distance between the two adjacent carryings 20.

The ceiling assembly 1 may include the sound-absorbing non-combustible ceiling material 10. The sound-absorbing non-combustible ceiling material 10 may include a frame unit 90. The frame unit 90 may refer to the connection portion 130 (see FIG. 3) of the first panel 100 (see FIG. 3). The frame unit 90 may be coupled to the clip bar 50. For example, the frame unit 90 may be coupled (or fastened) to the clip bar 50 by moving from below the clip bar 50 toward the clip bar 50. The frame unit 90 coupled to the clip bar 50 may be detached from the clip bar 50. For example, when an external force of a predetermined magnitude is applied to the frame unit 90 in a downward direction, the frame unit 90 coupled to the clip bar 50 may be detached from the clip bar 50.

An upper surface of the sound-absorbing non-combustible ceiling material 10 may face the ceiling. In FIG. 11, the upper surface of the sound-absorbing non-combustible ceiling material 10 may be observed. A lower surface of the sound-absorbing non-combustible ceiling material 10 may be observed indoors after the sound-absorbing non-combustible ceiling material 10 is installed. For example, the first panel 100 (see FIG. 3) of the sound-absorbing non-combustible ceiling material 10 may be observed indoors.

Referring to FIGS. 1 to 11, at least one of the first panel 100, the absorption layer 200, and the adhesive layer 300 according to an embodiment of the present disclosure may be non-combustible grade 1. Herein, non-combustible grade 1 may refer to a grade enough to pass the tests of the Korean Industrial Standards KS F ISO 1182 (non-combustibility test method of building materials) and KS F 2271 (flame retardant test method of interior materials and structures of buildings) established in accordance with Article 4 of the Industrial Standardization Act (hereinafter referred to as “the Korean Industrial Standards”).

For example, at least one of the first panel 100, the absorption layer 200, and the adhesive layer 300 according to an embodiment of the present disclosure may be tested according to the Korean Industrial Standards KS F ISO 1182 such that a maximum temperature in a furnace for 20 minutes of heating since the beginning of heating does not rise to exceed the final equilibrium temperature of 20K, and a mass reduction rate of a specimen after the end of heating is 30% or less, and may be tested according to the Korean Industrial Standards KS F 2271 such that an average behavioral stop time of experimental rats is 9 minutes or more.

Although the embodiments have been described with reference to a number of illustrative embodiments thereof, numerous other modifications and embodiments may be devised by those skilled in the art that will fall within the scope of the principles of the present disclosure. In particular, various variations and modifications are possible in the component parts and/or arrangements of the subject combination arrangement within the scope of the present disclosure, the drawings and the appended claims. In addition to variations and modifications in the component parts and/or arrangements, alternative uses will also be apparent to those skilled in the art. The scope of the present disclosure should be determined by rational interpretation of the appended claims, and all modifications within an equivalent scope of the present disclosure are included in the scope of the present disclosure.

[Description of reference numerals]

1: ceiling assembly
10: sound-absorbing non-combustible ceiling material
100: first panel
110: perforated plate
120: opening
130: connection portion
200: absorption layer
300: adhesive layer

1. A method (S100) for manufacturing a sound-absorbing non-combustible ceiling material installed in a ceiling of a building, the method comprising:
a panel processing step (S1000) of processing each of a first panel including a metal and a second panel absorbing a sound wave; and
a panel attaching step (S2000) of attaching the first panel and the second panel,
wherein the first panel includes a plurality of openings, and
wherein the first panel and the second panel are coupled by an adhesive layer to form the sound-absorbing non-combustible ceiling material.

2. The method (S100) of claim 1, wherein the panel processing step (S1000) comprises:
a first panel processing step (S1100) of processing a steel sheet to form the first panel; and
a second panel processing step (S1200) of forming the adhesive layer on the second panel.

3. The method (S100) of claim 2, wherein the second panel processing step (S1200) comprises a process of processing a glass fiber to form the second panel.

4. The method (S100) of claim 2, wherein the first panel processing step (S1100) comprises:
a perforated plate processing step (S1110) of forming the plurality of openings in a metal plate to form a perforated plate;
a connection portion processing step (S1120) of processing an edge portion of the perforated plate to form a connection portion; and
a connection portion bending step (S1130) of bending the connection portion with respect to the perforated plate.

5. The method (S100) of claim 4, wherein in the connection portion processing step (S1120),
the edge portion of the perforated plate forms a shape elongated in one direction, and an end of the edge portion of the perforated plate is chamfered to form the connection portion.

6. The method (S100) of claim 4, wherein in the connection portion processing step (S1120),
the edge portion of the perforated plate forms a shape elongated in one direction, and a hole is formed in the edge portion of the perforated plate.

7. The method (S100) of claim 2, wherein the second panel processing step (S1200) comprises:
a combination step (S1210) of coupling the adhesive layer to the second panel; and
a cutting step (S1220) of cutting the second panel.

8. The method (S100) of claim 7, wherein the combination step (S1210) comprises:
a laminating step (S1211) of disposing a material for forming the adhesive layer on one surface of the second panel;
a heat bonding step (S1212) of providing heat to the second panel and the material for forming the adhesive layer to form the adhesive layer by the material for forming the adhesive layer; and
a cooling step (S1213) of cooling the second panel and the adhesive layer.

9. The method (S100) of claim 2, wherein the panel attaching step (S2000) comprises:
a pressure providing step (S2100) of applying a pressure to the first panel and the second panel in a direction in which the first panel and the second panel approach each other; and
a heat providing step (S2200) of providing the heat to the first panel and the second panel.

10. The method (S100) of claim 2, wherein the steel sheet is plated with at least one of aluminum (Al) and zinc (Zn).

11. The method (S100) of claim 10, wherein a plating time of the steel sheet is 3 minutes to 15 minutes.

12. The method (S100) of claim 10, wherein a plating layer, that is formed as a layer by plating the steel sheet, forms a thickness of 5 μm to 50 μm.

13. The method (S100) of claim 2, wherein the steel sheet forms a thickness of 0.2 mm to 0.8 mm.

14. The method (S100) of claim 1, wherein the first panel includes:
a perforated plate facing the second panel;
the plurality of openings formed in the perforated plate; and
a connection portion formed to be bent and extended from the perforated plate.

15. The method (S100) of claim 14, wherein a ratio of an area of the openings to a total area of the perforated plate is 10% to 40%.

16. A sound-absorbing non-combustible ceiling material installed in a ceiling of a building, comprising:
a first panel including a plurality of openings;
a second panel accommodated in and coupled to the first panel, the second panel absorbing at least a portion of an incident sound wave; and
an adhesive layer positioned between the first panel and the second panel and coupling the first panel and the second panel,
wherein the first panel includes:
a perforated plate in which the plurality of openings are formed; and
a connection portion formed to be bent and extended from the perforated plate.

17. The sound-absorbing non-combustible ceiling material of claim 16, wherein the second panel includes silicon dioxide (SiO₂) with a weight ratio of 75% to 96%.

18. The sound-absorbing non-combustible ceiling material of claim 16, wherein the second panel forms a thickness of 0.2 mm to 1.3 mm.

19. The sound-absorbing non-combustible ceiling material of claim 16, wherein a ratio of an area of the openings to a total area of the perforated plate is 10% to 40%.
